(19) United States
(12) Patent Application Publication
(10) Pub. No.: US 2013/0264254 A1
(43) Pub. Date: Oct. 10, 2013

(54) OIL-CONTAINING WASTEWATER TREATMENT SYSTEM

(71) Applicants: Kenichi Ushikoshi, Sennan-gun (JP); Toru Morita, Sennan-gun (JP); Kiyoshi Ida, Sennan-gun (JP); Teizo Mizutani, Neyagawa-shi (JP)

(72) Inventors: Kenichi Ushikoshi, Sennan-gun (JP); Toru Morita, Sennan-gun (JP); Kiyoshi Ida, Sennan-gun (JP); Teizo Mizutani, Neyagawa-shi (JP)

(73) Assignee: SUMITOMO ELECTRIC FINE POLYMER, INC., Osaka (JP)

(21) Appl. No.: 13/976,584

(22) PCT Filed: Aug. 28, 2012
(86) PCT No.: PCT/JP2012/071628

§ 371 Date: Jun. 27, 2013

(30) Foreign Application Priority Data
Sep. 5, 2011 (JP) 2011-192916

(51) Int. Cl. C02F 1/44

(52) U.S. Cl. CPC C02F 1/44
USPC 210/151

(57) ABSTRACT

Devices used in an oil-containing wastewater treatment system are simplified by efficiently combining differences in processes used in the system.

The oil-containing wastewater treatment system includes a separation tank that separates oil by flotation, the separation tank being arranged in a supply path of raw water which is oil-containing wastewater; a membrane filtration tank that is arranged on the downstream of the separation tank and that includes therein a membrane separation module including a hollow fiber membrane or a flat sheet membrane, and a diffuser for generating air bubbles, the diffuser being disposed below the membrane separation module; a supply pipe that supplies the raw water from the separation tank to the membrane filtration tank through a circulating pump; and a return pipe that returns unfiltered water containing the oil and air bubbles from the membrane filtration tank to the separation tank.

### TECHNICAL FIELD

The present invention relates to an oil-containing wastewater treatment system, and in particular, to an oil-containing wastewater treatment system which combines separation in a pre-treatment process including flotation and sedimentation with membrane filtration in a post-treatment process and in which an efficient treatment is performed by combining the function in the pre-treatment process with the function in the post-treatment process.

### BACKGROUND ART

Various treatment apparatuses and treatment methods for removing oil from oil-containing wastewater have been proposed. In general, in oil-containing wastewater treatment, a pre-treatment including coagulating sedimentation/pressure flotation or the like is performed, and a post-treatment including filtration, a treatment with activated carbon, etc. is then performed. However, in such a treatment system in which a plurality of wastewater treatment processes are successively performed, the amount of water that can be treated decreases as the treatment processes proceed. Thus, such a treatment system has a problem in that, when oil-containing wastewater is discharged in a large amount, the treatment of the oil-containing wastewater does not keep up with the discharge. Accordingly, in treatment of oil-containing wastewater discharged in a large amount, precise separation means is not suitable in view of the treatment speed.

In Japanese Unexamined Patent Application Publication No. 2010-36183, the applicant of the present invention provides a membrane separation device including a hollow fiber membrane that removes oil by membrane filtration, the membrane separation device being used in a treatment after a pre-treatment including coagulating sedimentation/pressure flotation, or the like. The membrane separation device includes an alkali-resistant hollow fiber membrane selected from polytetrafluoroethylene (PTFE), polysulfone (PSF), and polyethersulfone (PES), and thus the hollow fiber membrane is a chemically and physically tough membrane. Accordingly, the use of this membrane separation device is advantageous in that washing can be efficiently performed and a large amount of wastewater can be treated by increasing the treatment speed.

### CITATION LIST

### Patent Literature

PTL 1: Japanese Unexamined Patent Application Publication No. 2010-36183

### SUMMARY OF INVENTION

### Technical Problem

In an oil-containing wastewater treatment system disclosed in PTL 1, devices for coagulating sedimentation, flotation separation, and sand filtration that are used in a pre-treatment process and the membrane separation device for membrane filtration used in a post-treatment process are connected to each other through pipes. However, the operations conducted in the devices are independent from each other, and the operations and the facilities in the pre-treatment process and the post-treatment process are not combined. Consequently, the installation area of the treatment system is large, and a further improvement is desired from the standpoint of increasing the efficiency of the whole system.

The present invention has been made in view of the above problem. An object of the present invention is to simplify operations and devices by efficiently combining a membrane filtration device for conducting a microfiltration treatment in a post-treatment process with a separation device for flotation/sedimentation in a pre-treatment process from the standpoint of the operations and the devices.

### Solution to Problem

To achieve the above object, the present invention provides an oil-containing wastewater treatment system including a separation tank that separates oil by flotation, the separation tank being arranged in a supply path of raw water which is oil-containing wastewater; a membrane filtration tank that is arranged on the downstream of the separation tank and that includes therein a membrane separation module including a hollow fiber membrane or a flat sheet membrane, and a diffuser for generating air bubbles, the diffuser being disposed below the membrane separation module; a supply pipe that supplies the raw water from the separation tank to the membrane filtration tank through a circulating pump; and a return pipe that returns unfiltered water containing the oil and air bubbles from the membrane filtration tank to the separation tank.

As described above, a diffuser that generates air bubbles is arranged below a membrane separation module in a membrane filtration tank, and air bubbles are generated by bubbling of air for aeration. By the bubbling in water, coarse air bubbles provide vibrations to a separation membrane and generate an upward flow of the air bubbles, thus separating oil-containing foreign substances adhering to a surface of the separation membrane, and suppressing clogging of the separation membrane. Consequently, a decrease in the flow rate of membrane filtration is prevented. A very small amount of oil separated from the surface of the separation membrane is deposited by continuous separation thereof. The deposited oil is associated to form a large oil droplet and floats in the membrane filtration tank. The flow rate generated by the circulating pump brings an effect of separating oil and solid matter deposited on the surface of the membrane. Furthermore, since a return pipe is provided from the membrane filtration tank to a separation tank, the oil floating in the membrane filtration tank is sent to the separation tank through the return pipe, floats in the separation tank, and become separable. On the other hand, unfiltered water containing air bubbles is caused to flow from the return pipe to the separation tank so as to supply the air bubbles at an appropriate position of the separation tank. Consequently, an upward flow of the air bubbles is generated, oil in the separation tank is caused to adhere to the air bubbles and to float, and thus the oil can be efficiently separated in the separation tank. In this case, prior to the supply of the unfiltered water into the separation tank, the unfiltered water may be mixed with raw water that is newly supplied. With this structure, the oil can be separated more efficiently.

As described above, the separation tank is connected to the membrane filtration tank through the return pipe so that clogging of the membrane is suppressed by coarse air bubbles generated by the diffuser in the membrane filtration tank in the post-treatment process and fine air bubbles are returned to the separation tank in the pre-treatment process. With this structure, simplification of the process and a reduction in the installation area can be realized by functionally combining facilities and operations in the pre-treatment process and the post-treatment process.

The supply pipe connecting the separation tank to the membrane filtration tank communicates with a middle region of the separation tank in the vertical direction and communicates with a lower portion of the membrane filtration tank, and the return pipe communicates with an upper portion of the membrane filtration tank. Part of circulating water supplied from the separation tank to the membrane filtration tank becomes treated water that has been subjected to membrane filtration, and the remaining part of the circulating water becomes unfiltered water and is returned to the separation tank. The higher the flow rate of the circulating water, the higher the effect of suppressing clogging of the membrane in the membrane filtration tank. In such a case, however, the flow rate of the unfiltered water returning to the separation tank is increased. As a result, the liquid level in the separation tank significantly varies, and floating oil and settling coagulated sediment may be stirred and may not be easily separated from each other.

Accordingly, a guide pipe is preferably arranged on an outer periphery of each of the membrane separation modules or on an outer periphery of a plurality of the membrane separation modules with a gap therebetween, and the air bubbles and the raw water are preferably allowed to flow from an opening at a lower end of the guide tube and discharged from an opening at an upper end of the guide pipe.

With this structure, air bubbles can be efficiently raised in the guide pipe, and thus dissipation of air bubbles can be prevented. As a result, the effect of providing vibrations to the membrane etc. can be made more significant, a circulation flow rate, that is, a return flow rate from the membrane filtration tank to the separation tank can also be reduced accordingly, the amount of treated water circulated by the circulating pump can be reduced, and the significant variation in the liquid level in the separation tank can be prevented. Consequently, even when a cross-sectional area necessary for the separation tank is reduced, floating oil and sediment can be easily removed, and thus the initial cost of the separation tank can also be reduced.

In the separation tank, oil and foreign substances having a low specific gravity float in the vicinity of the level of the stored liquid, and sludge having a high specific gravity is deposited on a bottom portion of the separation tank. Therefore, a raw water outlet of the supply pipe is preferably provided in a middle region in the vertical direction where large amounts of oil and foreign substances are not present. In the membrane filtration tank, air bubbles rising in water are preferably caused to act on the separation membrane and then taken out. Therefore, an outlet of the return pipe is preferably provided on the upper side of the membrane filtration tank.

The diffuser arranged in the membrane filtration tank supplies pressure air from an air source to an aeration pipe arranged below the membrane separation module, and provides vibrations to the hollow fiber membrane or the flat sheet membrane in the membrane separation module by air bubbles generated from an injection hole of the aeration pipe. Fine air bubbles are also present in the air bubbles, and these fine air bubbles have an effect of causing a very small amount of oil in the tank to float. Preferably, a fine air bubble diffuser including a hole having a smaller diameter is separately provided, and fine air bubbles may be intentionally generated so that the very small amount of oil in the membrane filtration tank is caused to float and introduced to the return pipe. Alternatively, a single aeration pipe may include a hole for a coarse air bubble and a hole for fine air bubble.

The air source that supplies the pressure air to the aeration pipe is preferably a blower or a compressor.

A scum skimmer is preferably arranged at a position of a liquid level in the separation tank and connected to a drive shaft of a motor so that floating oil is collected and discharged with the scum skimmer, and a sludge raking device is preferably connected to a lower end of the drive shaft of the motor and arranged on a bottom surface of the separation tank so as to rake and discharge settling sludge.

The filtration membrane of the membrane separation module arranged in the membrane filtration tank may be a hollow fiber membrane or a flat sheet membrane. In particular, in order to obtain the separation effect by vibrations of the membrane, a hollow fiber membrane is preferable. Among flat sheet membranes, a flexible flat sheet membrane can be suitably used. Regarding the material of the membrane, an alkali-resistant porous membrane selected from polytetrafluoroethylene (PTFE), polysulfone (PSF), and polyethersulfone (PES) is preferably used. Among these membranes, a preferred membrane is a membrane having a strength that can withstand the pressure due to back washing or vibrations caused by aeration performed in order to maintain the treatment flow rate. Specifically, the membrane preferably has a tensile strength of 30 N or more.

A membrane separation module including a hollow fiber membrane or flat sheet membrane, which is a porous separation membrane selected from PTFE, PSF, and PES, has excellent performance for removing water-insoluble oil, chemical resistance, in particular, alkali resistance, and durability (i.e., the module can be used for a long time while exhibiting a normal filtration performance). As a result, the membrane separation module can be repeatedly used by dissolving and removing water-insoluble oil adhering to the surface of the membrane by chemical washing with an aqueous alkaline solution while realizing high-performance filtration that can reduce the content of the water-insoluble oil. Accordingly, the high-performance filtration can be maintained for a long time.

The oil-containing wastewater treatment system of the present invention can be used as an oil-containing wastewater treatment system in various fields such as treatment of oilfield-produced water and oil-containing industrial wastewater. The oil-containing wastewater treatment system of the present invention is particularly useful in, for example, desalination of seawater that contains oil. For example, when a nuclear power plant is destroyed by, for example, the damage due to a tsunami caused by an earthquake, radioactive wastewater is generated, and the treatment of the radioactive wastewater becomes necessary. In such a case, prior to the removal of radioactive substances, the removal of oil in seawater is necessary as a pre-treatment. In this case, the oil can be stably removed with high accuracy, and the efficiency of a post-treatment such as adsorption of the radioactive substances can be increased.

### Advantageous Effects of Invention

As described above, according to the oil-containing wastewater treatment system of the present invention, a return pipe is arranged between a separation tank on the upstream side and a membrane filtration tank on the downstream side to supply a circulating flow to a membrane separation module disposed in the membrane filtration tank, and an upward flow of air bubbles by aeration and a cleaning effect of a surface of a membrane due to vibrations are added from a lower portion of the membrane separation module. With this structure, a stable filtration performance of the membrane is maintained and floating oil is transferred from the membrane filtration tank to the separation tank to remove the oil in the membrane filtration tank. In addition, unfiltered water containing air bubbles is circulated from the membrane filtration tank to the separation tank. Accordingly, air bubbles can be present in the separation tank without providing a diffuser in the separation tank, oil is allowed to adhere to the air bubbles during rising of the air bubbles, and thus the oil can be efficiently separated by flotation. By connecting the separation tank to the membrane filtration tank through the return pipe and the supply pipe in this manner to combine the separation tank with the membrane filtration tank, the process can be simplified and the installation area can be reduced.

In particular, by vibrating the separation membrane by coarse air bubbles generated in the membrane filtration tank, foreign substances adhering to the membrane surface can be separated to suppress a decrease in the filtration performance. In addition, by circulating fine air bubbles in the separation tank, the fine air bubbles can be effectively contributed to the separation of oil by flotation. Furthermore, since the membrane filtration tank is arranged on the downstream of the separation tank that performs separation using the specific gravity and membrane filtration is performed using a separation membrane, the quality of treated water can be improved and the operational stability can be enhanced.

### BRIEF DESCRIPTION OF DRAWINGS

FIG. 1 is an overall view of an oil-containing wastewater treatment system according to an embodiment of the present invention.

FIG. 2 is an enlarged view of a membrane filtration tank illustrated in FIG. 1.

FIG. 3 is an enlarged view of the relevant part of a modification of a diffuser.

FIG. 4A is a view illustrating a first modification of a membrane separation module.

FIG. 4B is a view illustrating the first modification of a membrane separation module, and illustrates an arrangement of modules and guide pipes.

FIG. 5 is a view illustrating a second modification of a membrane separation module.

### DESCRIPTION OF EMBODIMENTS

Embodiments of the present invention will now be described with reference to the drawings.

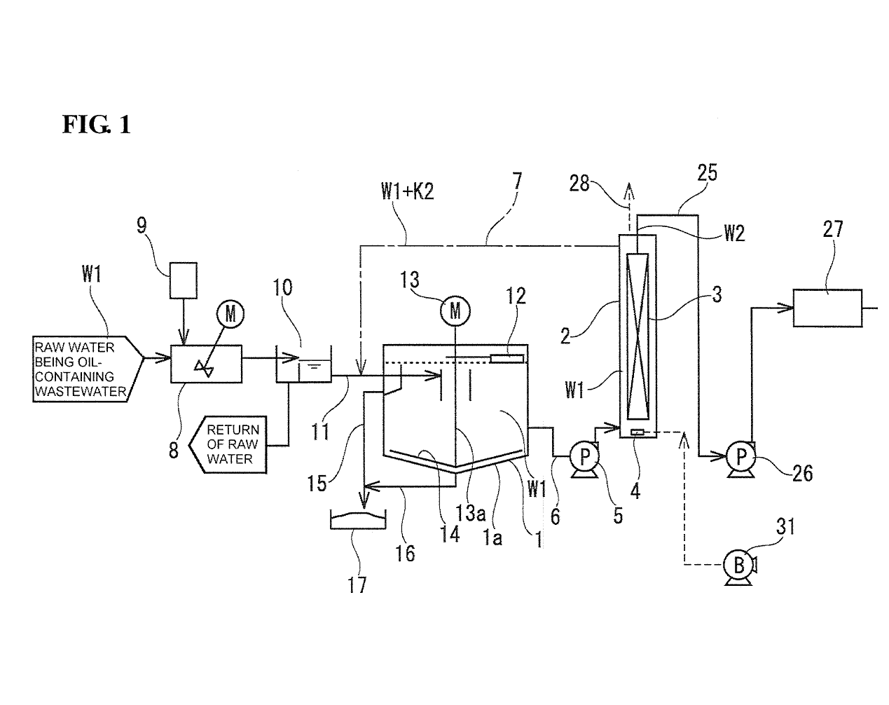

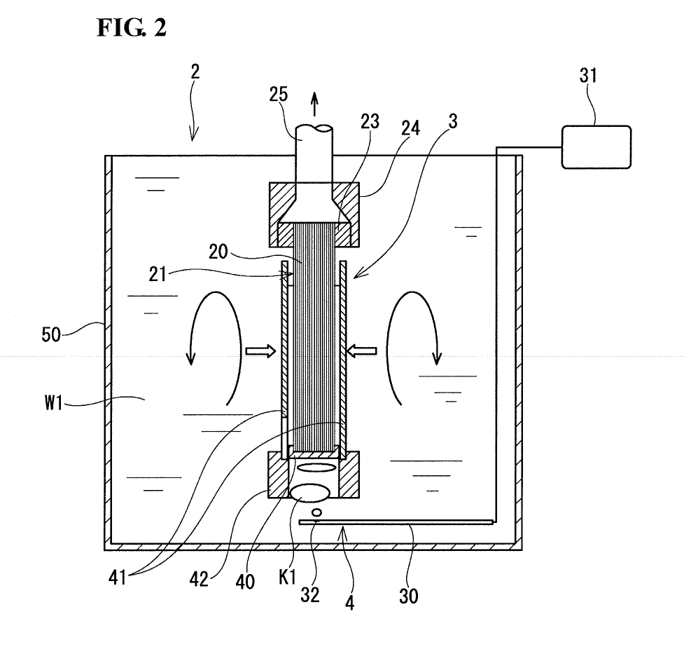

FIGS. 1 and 2 illustrate an embodiment of the present invention.

In the overall view illustrated in FIG. 1, reference numeral 1 denotes a separation tank that separates foreign substances by flotation and sedimentation, and reference numeral 2 denotes a membrane filtration tank that filters foreign substances with a membrane.

The membrane filtration tank 2 houses a hollow fiber membrane module (membrane separation module) 3 and a diffuser 4 that generates air bubbles, the diffuser 4 being disposed below the hollow fiber membrane module 3.

A middle region of the separation tank 1 in the vertical direction is connected to a lower region of the membrane filtration tank 2 through a supply pipe 6 with a pump 5 therebetween. In addition, a return pipe 7 that connects an upper region of the membrane filtration tank 2 to an upper region of the separation tank 1 is provided so that unfiltered water containing air bubbles is returned from the return pipe 7 to the separation tank 1 to circulate the unfiltered water.

Raw water W1 which is oil-containing wastewater and which is supplied to the separation tank 1 is temporarily stored in a chemical mixing tank 8. A pH adjusting agent, an adsorbent, a flocculant, etc. are injected as required from a chemical injection unit 9 into the chemical mixing tank 8. The raw water W1 is supplied from the chemical mixing tank 8 to a liquid level adjusting tank 10. The raw water W1 is supplied from the liquid level adjusting tank 10 to the separation tank 1 through a raw water supply pipe 11.

The separation tank 1 is a tank that separates oil and foreign substances by causing the oil and foreign substances to float on the liquid surface side and to settle on the bottom side in accordance with the specific gravities of the oil and foreign substances.

A scum skimmer 12 that collects foreign substances floating on an upper portion of the separation tank 1 is arranged on the liquid surface. The scum skimmer 12 is fixed to a drive shaft 13a hung from a motor 13 arranged above the separation tank 1. The scum skimmer 12 is rotated in the horizontal direction by the motor 13 to collect foreign substances containing floating oil. The lower end of the drive shaft 13a is located on a bottom wall 1a of the separation tank 1, the bottom wall 1a projecting in the form of a cone shape, and connected to a sludge raking device 14 arranged along the bottom wall 1a. The sludge raking device 14 is rotated so that sludge settling on the upper surface side of the bottom wall 1a is raked to the central lowermost end.

A scum discharge pipe 15 is open to and connected to the lower surface side of the scum skimmer 12, and a sludge discharge pipe 16 is open to and connected to the lowermost end of the separation tank 1. Another end of the scum discharge pipe 15 and another end of the sludge discharge pipe 16 are connected to a scum/sludge receiving tank 17.

The raw water supply pipe 11 that supplies the raw water W1 from the liquid level adjusting tank 10 is open at a position on the lower surface side of the scum skimmer 12 of the separation tank 1. The return pipe 7 communicates with the raw water supply pipe 11 so that unfiltered water containing air bubbles and circulating through the return pipe 7 is combined with the raw water W1, and the resulting mixed water is supplied to an upper region of the separation tank 1. By supplying air bubbles to the separation tank 1 in this manner, oil is caused to adhere to the air bubbles and to easily float, and the oil is caused to easily adhere to the scum skimmer 12. Alternatively, the return pipe 7 may be separately connected to the separation tank 1 without being connected to the raw water supply pipe 11.

An outlet of the supply pipe 6 is open in a sidewall of the separation tank 1, the sidewall being opposite to the sidewall connected to the raw water supply pipe 11, and in a middle region not higher than the position at which the scum skimmer 12 is arranged and not lower than the position at which the sludge raking device 14 is arranged. Since the pump 5 is arranged at a midpoint of the supply pipe 6, a separated liquid in the separation tank 1 is suctioned into the supply pipe 6 and is supplied into the membrane filtration tank 2 from an opening provided in a lower portion of a sidewall of the membrane filtration tank 2. In the present embodiment, the discharge pressure of the pump 5 is 50 to 300 kPa.

The membrane filtration tank 2 is an immersion tank including an air valve, etc. The membrane filtration tank 2 houses the hollow fiber membrane module 3 and the diffuser 4 that generates air bubbles, the diffuser 4 being disposed below the hollow fiber membrane module 3. The hollow fiber membrane module 3 and the diffuser 4 are immersed in the raw water W1 supplied from the supply pipe 6.

The hollow fiber membrane module 3 is an immersion-type module in which the raw water W1 is permeated from the outside of a hollow fiber membrane 20 to the inside thereof by suctioning the raw water W1 from the inside of the hollow fiber membrane 20.

The hollow fiber membrane module 3 includes a bundled body 21 in which a plurality of hollow fiber membranes 20 (3,500 hollow fiber membranes in the present embodiment) are bundled. Lower end openings of the hollow fiber membranes 20 are closed with a fixing member 40. Upper ends of the hollow fiber membranes 20 are open and fixed with a fixing member 23. An upper cap 24 is attached to the fixing member 23. The fixing member 23 is connected to the fixing member 40 through a support rod 41, and a skirt member 42 that protrudes downward is fixed to the fixing member 40.

An outlet that communicates with the inside of the upper cap 24 and with hollow portions of the hollow fiber membranes 20 is provided, and the outlet is connected to a filtered liquid outlet pipe 25. A filtered liquid W2 is introduced to a post-treatment tank 27 through the filtered liquid outlet pipe 25 with a suction pump 26 therebetween. As the post-treatment tank 27, adsorption with activated carbon, a biological treatment/sedimentation treatment, a reverse osmosis membrane treatment, etc. may be added.

An air vent pipe 28 is attached to an upper wall of the membrane filtration tank 2. In addition, a discharge port of untreated water that has not been filtered is provided on an upper portion of the sidewall of the membrane filtration tank 2, and the discharge port communicates with the return pipe 7.

The diffuser 4 arranged below the hollow fiber membrane module 3 includes an air introducing pipe 30 for aeration connected to a blower 31. Injection holes 32 provided in the air introducing pipe 30 for aeration are arranged below the hollow fiber membrane module 3 so that air is injected from the injection holes 32 into the skirt member 42. A plurality of the injection holes 32 having the same diameter are provided. Coarse air bubbles K1 and some fine air bubbles K2 are generated from air injected from a single injection hole 32.

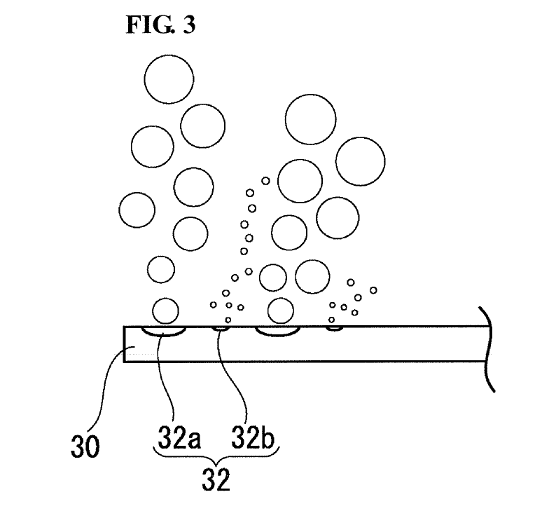

As illustrated in a modification in FIG. 3, large-diameter holes 32a for generating coarse air bubbles and small-diameter holes 32b for generating fine air bubbles may be provided as the injection holes 32. In order to form the small-diameter holes 32b, for example, a pipe or membrane material of a hydrophobic porous membrane is suitably used.

During the operation of filtration, the diffuser 4 constantly performs aeration from a lower portion toward the hollow fiber membranes 20 of the bundled body 21. The diffuser 4 generates coarse air bubbles K1 and fine air bubbles K2 in the raw water W1 in the upward direction. Among these air bubbles, the coarse air bubbles K1 mainly vibrate the hollow fiber membranes 20 and separate foreign substances adhering to the membrane surfaces of the hollow fiber membranes 20, thereby preventing the hollow fiber membranes 20 from being clogged. In addition, the coarse air bubbles K1 are released to the atmosphere through the air vent pipe 28. On the other hand, the fine air bubbles K2 are introduced from the return pipe 7 arranged in an upper portion of the membrane filtration tank 2, and circulated in the separation tank 1.

The hollow fiber membranes 20 used in the present embodiment are each a porous two-layer hollow fiber membrane including a support layer that is a porous stretched PTFE tube, and a filtration layer that is a porous stretched PTFE sheet and that is disposed on the outer surface of the support layer. The hollow fiber membranes 20 may be further hydrophilized with a hydrophilic polymer or the like. An average maximum length of a large number of pores provided on the outer circumferential surface of the filtration layer is smaller than an average maximum length of a large number of pores provided in the support layer and surrounded by a fibrous skeleton. Specifically, an average length of the pores of the filtration layer is preferably 1% to 30% of an average length of the pores of the support layer, and is preferably as small as possible. This structure can increase permeability from the outer circumferential surface side to the inner circumferential surface side.

On an outer surface of the filtration layer, the occupancy ratio of the area of the pores to the total surface area of the outer surface is 30% to 90% measured by image processing. Even in the case where the maximum length of the pores is small, when the occupancy ratio of the area of the pores is high to some extent, filtration performance can be efficiently improved without decreasing the flow rate.

Specifically, the porosity of the filtration layer is 30% to 80%, and the porosity of the support layer is 50% to 85%. With this structure, permeability from the outer circumferential surface side to the inner circumferential surface side of the hollow fiber membrane can be further increased while maintaining the balance with the strength.

The filtration layer has a thickness of 5 to 100 μm. The reason for this is as follows. When the thickness is smaller than the above range, it is difficult to form the filtration layer. When the thickness is larger than the above range, it is difficult to expect the effect of improving the filtration performance. The support layer has a thickness of 0.1 to 5 mm. With this structure, a good strength can be obtained in the axial direction, the radial direction, and the circumferential direction, and durability against the internal pressure, external pressure, flexion, etc. can be improved. The support layer has an inner diameter of 0.3 to 12 mm.

The filtration layer has an average pore diameter of 0.01 to 1 μm.

The hollow fiber membrane 20 preferably has, as the whole hollow fiber membrane, an inner diameter of 0.3 to 12 mm, an outer diameter of 0.8 to 14 mm, a bubble point of 50 to 400 kPa, a membrane thickness of 0.2 to 1 mm, a porosity of 30% to 90%, and durability of a maximum permissible transmembrane pressure difference of 0.1 to 1.0 MPa.

The hollow fiber membranes 20 each have a tensile strength of 30 N or more.

The tensile strength is measured in accordance with JIS K 7161, and a hollow fiber membrane is used as a specimen without further treatment. In the test, the measurement was conducted at a tensile speed of 100 mm/min, a distance between gauge lines of 50 mm. Since the hollow fiber membranes 20 have a heat distortion temperature of 100° C. or higher, thermal degradation does not easily occur even when the hollow fiber membranes 20 are used for a long time.

In the hollow fiber membrane module 3 including the bundled body 21 of the hollow fiber membranes 20, an average dimension between the hollow fiber membranes 20 in the bundled body 21 is relatively large, namely, 0.5 to 5 mm, and a filling ratio of the hollow fiber membranes 20 to the cross-sectional area of the bundled body 21 is 20% to 60%.

In the present embodiment, during the operation of filtration, air is constantly injected from the diffuser 4 to generate the coarse air bubbles K1 and the fine air bubbles K2 in the membrane filtration tank 2. These air bubbles are raised while conducting bubbling in the raw water W1 which is oil-containing wastewater in the tank 50 to generate a circulating flow.

In this case, as described above, water-insoluble oil and solid matter adhering to the membrane surfaces of the hollow fiber membranes 20 are vibrated and removed while vibrating the hollow fiber membranes 20 by the coarse air bubbles K1.

The fine air bubbles K2 are mixed with raw water W1 that has not been filtered and introduced to the return pipe 7. Since the return pipe 7 communicates with the raw water supply pipe 11, the fine air bubbles K2 and the raw water W1 that has not been filtered are mixed with raw water W1 and introduced to the separation tank 1. Since the fine air bubbles K2 are introduced into the separation tank 1 in this manner, oil adheres to the fine air bubbles K2 in the separation tank 1 and the oil easily floats together with the fine air bubbles K2 and can be efficiently collected with the scum skimmer 12.

As described above, foreign substances containing oil and sludge are separated from oil-containing wastewater in the separation tank 1 by flotation separation of oil and sedimentation separation of sludge, and the raw water W1 is then supplied to the membrane filtration tank 2. Accordingly, foreign substances containing oil and sludge that adhere to the surfaces of the hollow fiber membranes 20 of the hollow fiber membrane module 3 arranged in the membrane filtration tank 2 can be reduced. Consequently, the performance of membrane filtration of the hollow fiber membranes 20 does not decrease, and a decrease in the amount of water treated can be prevented. In addition, since air bubbles generated by the diffuser 4 used in the membrane filtration tank 2 are functionally used by being circulated in the separation tank 1, the separation function in the separation tank 1 can be enhanced. Furthermore, a diffuser that generates air bubbles need not be provided in the separation tank. Thus, the facilities can be simplified, and the installation area thereof can be reduced.

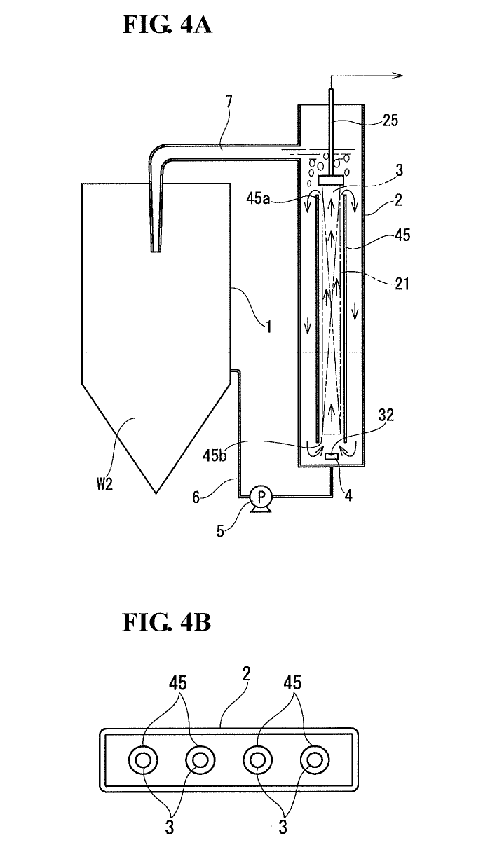

FIGS. 4A and 4B illustrate a first modification of the membrane filtration tank 2.

A plurality of hollow fiber membrane modules 3 are immersed in a membrane filtration tank 2. A guide pipe 45 covers each of the hollow fiber membrane modules 3 with a gap between the guide pipe 45 and the outer periphery of a bundled body 21 of hollow fiber membranes 20. An upper end of the guide pipe 45 constitutes an opening 45a and a lower end of the guide pipe 45 constitutes an opening 45b. Raw water W1 flows from the opening 45b at the lower end into the inside of the guide pipe 45 and is filtered through the hollow fiber membranes 20. Raw water W1 that has not been filtered flows from the opening 45a at the upper end and flows downward on the outer peripheral side of the guide pipe 45. The raw water W1 circulates in this manner. Air injected from a diffuser 4 is also injected from the opening 45b at the lower end into the guide pipe 45.

In the case where air and raw water W1 are allowed to flow into the guide pipe 45, even when a circulation flow rate of the raw water W1 is decreased, the linear velocity of the raw water W1 flowing through the guide pipe 45, that is, flowing in the vicinity of membrane surfaces of the bundled body 21 of the hollow fiber membranes 20, is high. Thus, solid matter and oil deposited on the membrane surfaces of the hollow fiber membranes 20 can be more efficiently separated. In addition, air bubbles generated can be efficiently loaded on the surfaces of the hollow fiber membranes 20 to swing the hollow fiber membranes. Accordingly, the amount of air supplied can be reduced to reduce the running cost. Furthermore, since the flow rate of unfiltered water returned from the membrane filtration tank 2 to the separation tank 1 is decreased, it is possible to reduce the cross-sectional area of the separation tank necessary for realizing rapid sedimentation, and it is also possible to reduce the initial cost.

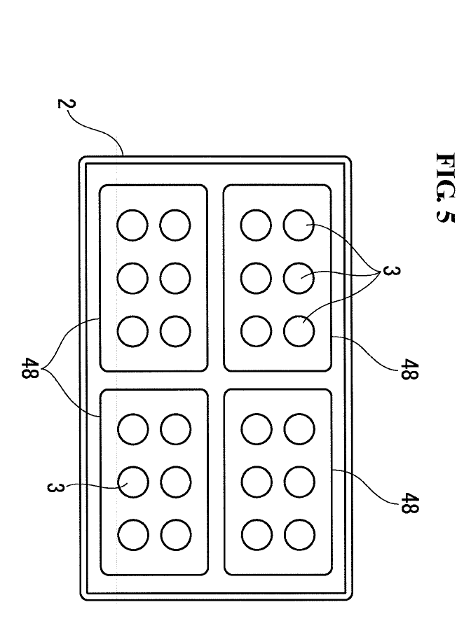

FIG. 5 illustrates a second modification.

In the second modification, a plurality of hollow fiber membrane modules 3 immersed in a membrane filtration tank 2 are divided into a plurality of groups (in the present embodiment, 24 hollow fiber membrane modules 3 arranged in the horizontal and vertical directions are divided into four groups), and each group of the hollow fiber membrane modules 3 is covered with a single guide pipe 48. By relatively densely arranging the hollow fiber membrane modules 3 and coveting them with a single guide pipe 48 in this manner, the hollow fiber membrane modules can be arranged in the membrane filtration tank 2 with a high density.

In the above embodiments and modifications, a bundled body of hollow fiber membranes is used as the hollow fiber membrane module 3 arranged in the membrane filtration tank 2. Alternatively, flat sheet membranes may be used instead of the hollow fiber membranes. Also in the case where the flat sheet membranes are used, a diffuser that generates air bubbles is arranged below the membrane module, as in the above embodiments.

### REFERENCE SIGNS LIST

1 separation tank

2 membrane filtration tank

3 hollow fiber membrane module

4 diffuser

6 supply pipe

7 return pipe

K1 coarse air bubble

K2 fine air bubble

W1 raw water

W2 filtered liquid

1. An oil-containing wastewater treatment system comprising:
a separation tank that separates oil by flotation, the separation tank being arranged in a supply path of raw water which is oil-containing wastewater;
a membrane filtration tank that is arranged on the downstream of the separation tank and that includes therein a membrane separation module including a hollow fiber membrane or a flat sheet membrane, and a diffuser for generating air bubbles, the diffuser being disposed below the membrane separation module;
a supply pipe that supplies the raw water from the separation tank to the membrane filtration tank through a circulating pump; and
a return pipe that returns unfiltered water containing the oil and air bubbles from the membrane filtration tank to the separation tank.

2. The oil-containing wastewater treatment system according to claim 1, wherein a guide pipe is arranged on an outer periphery of each of the membrane separation modules or on an outer periphery of a plurality of the membrane separation modules with a gap therebetween, and the air bubbles and the raw water are allowed to flow from an opening at a lower end of the guide pipe and discharged from an opening at an upper end of the guide pipe.

3. The oil-containing wastewater treatment system according to claim 1, wherein a separation membrane of the membrane separation module arranged in the membrane filtration tank is a porous membrane selected from polytetrafluoroethylene (PTFE), polysulfone (PSF), and polyethersulfone (PES).

4. The oil-containing wastewater treatment system according to claim 1, wherein the supply pipe connecting the separation tank to the membrane filtration tank communicates with a middle region of the separation tank in the vertical direction and communicates with a lower portion of the membrane filtration tank, and the return pipe communicates with an upper portion of the membrane filtration tank.

5. The oil-containing wastewater treatment system according to claim 1, wherein the diffuser arranged in the membrane filtration tank supplies pressure air from an air source to an aeration pipe arranged below the membrane separation module, the aeration pipe having a large-diameter hole and a small-diameter hole, provides vibrations to the hollow fiber membrane or the flat sheet membrane in the membrane separation module by coarse air bubbles generated from the large-diameter hole, and introduces fine air bubbles from the small-diameter hole to the return pipe.

6. The oil-containing wastewater treatment system according to claim 1, wherein a scum skimmer is arranged at a position of a liquid level in the separation tank and connected to a drive shaft of a motor so that floating oil is collected and discharged with the scum skimmer, and a sludge raking device is connected to a lower end of the drive shaft of the motor and arranged on a bottom surface of the separation tank so as to rake and discharge settling sludge.
